(19) United States
(12) Patent Application Publication
(10) Pub. No.: US 2014/0111042 A1
(43) Pub. Date: Apr. 24, 2014

(54) HOUSING UNIT AND ELECTRIC MACHINE COMPRISING A HOUSING UNIT

(71) Applicant: SIEMENS AKTIENGESELLSCHAFT, München (DE)

(72) Inventor: Rainer Hartig, Buxtehude (DE)

(73) Assignee: SIEMENS AKTIENGESELLSCHAFT, Munich (DE)

(21) Appl. No.: 14/119,494

(22) PCT Filed: May 18, 2012
(86) PCT No.: PCT/EP2012/059294

§ 371 Date: Nov. 22, 2013

(30) Foreign Application Priority Data
May 25, 2011 (DE) 102011076452.6

(51) Int. Cl. H02K 9/06

(52) U.S. Cl. CPC H02K 9/06
USPC 310/62

(57) ABSTRACT

An embodiment of the invention relates to a housing unit for an electric machine, including at least one housing and at least one flow device for generating at least one first flow of a fluid, the flow device being arranged inside the at least one housing. According to an embodiment of the invention, the at least one flow device includes at least one fan, which has at least one opening and a Coanda surface, wherein the Coanda surface is arranged in the region of the opening, whereby the first flow of the fluid exits from the at least one opening in a predetermined direction and whereby at least one component, which can be arranged in the housing, can be subjected to incident blowing in a targeted manner.

### PRIORITY STATEMENT

This application is the national phase under 35 U.S.C. §371 of PCT International Application No. PCT/EP2012/059294 which has an International filing date of May 18, 2012, which designated the United States of America and which claims priority to German patent application number DE 10 2011 076 452.6 filed May 25, 2011, the entire contents of each of which are hereby incorporated herein by reference.

### FIELD

At least one embodiment of the invention generally relates to a housing unit for an electric machine comprising at least one housing and comprising at least one flow device for generating at least one first flow of a flow medium, the flow device being arranged inside the at least one housing.

### BACKGROUND

Different types of cooling of components of an electric machine are known. These can also be arranged differently in or on a housing unit. Pure air cooling within a housing by driving a fan by way of a rotor of the electric machine might be mentioned here for instance. Also known is an air cooling in which air is supplied to an electric machine via external fans, wherein the air, after passing through components of the electric machine to be cooled, is be re-cooled by a water cooler also arranged externally. Furthermore there is also the possibility of direct cooling of windings of winding heads of an electric machine for example by means of fluid cooling. In addition water jacket cooling of a stator is also known.

### SUMMARY

At least one embodiment of the present invention provides a housing unit in which there can be good dissipation of heat losses.

In at least one embodiment, a housing unit is described in which at least one flow device has at least one fan which has at least one opening and a Coanda surface, wherein the Coanda surface is arranged in the region of the opening, whereby the first flow of the flow medium exits from the at least one opening in a predetermined direction and whereby at least one component which can be arranged in the housing can be subjected to incident blowing in a targeted manner.

### BRIEF DESCRIPTION OF THE DRAWINGS

The invention will be explained in greater detail with reference to example embodiments, which are shown in the drawings.

In the drawings:

FIG. 1 shows an electric machine with an embodiment of inventive housing unit in an overview diagram,

FIG. 2 shows a cross-section of an embodiment of the inventive housing unit of FIG. 1 with a flow device,

FIG. 3 shows the flow device of FIG. 2 in a frontal view,

FIG. 4 shows a cross-section along the line IV-IV through the flow device of FIG. 3,

FIG. 5 shows a perspective and enlarged view of a part of the flow device of FIG. 4 and

FIG. 6 shows a cross-section of an alternate housing unit with a flow device embodied in one piece with the housing.

### DETAILED DESCRIPTION OF THE EXAMPLE EMBODIMENTS

In at least one embodiment, a housing unit is described in which at least one flow device has at least one fan which has at least one opening and a Coanda surface, wherein the Coanda surface is arranged in the region of the opening, whereby the first flow of the flow medium exits from the at least one opening in a predetermined direction and whereby at least one component which can be arranged in the housing can be subjected to incident blowing in a targeted manner.

The inventive embodiment enables an energy-efficient and even cooling of the components arranged in the housing unit to be carried out. In addition large-volume add-ons, such as auxiliary cooling units on the electrical machine for example, as are usual in the prior art, can be dispensed with. Consequently a space-saving arrangement can be provided. Furthermore the inventive embodiment offers a higher power density compared to prior art arrangements. This leads to a compact housing unit and accordingly to a compact electric machine. Such a housing unit is also a low-noise unit.

In this context an electric machine is to be understood as a motor or generator, such as for example a low voltage machine, a high-temperature superconductor (HTS) motor, a permanent magnet (PM) motor, and/or any other machine appearing conceivable to the person skilled in the art. A housing unit is to be understood in this context as a unit which encloses components of the electric machine such as a shaft, a rotor, a stator, a winding head, a circuit, a fuse, a transmission component such as a gear wheel or a coupling and/or any other component deemed sensible by a person skilled in the art, at least partly or preferably completely. The housing unit can have a single housing or a number of housings, such as an inner and an outer housing for example. A flow device is intended here to represent a device which actively affects a flow of a flow medium such as the fluid, a gas and especially air. The flow device has at least one fan but can also have other components such as a deflection shield for example.

A fan is to be understood here as a device which accelerates the flow medium or air. Preferably the fan is embodied without vanes, wherein without vanes means that the flow of the flow medium, which is emitted or expelled, occurs without the aid of vanes, rotor blades or a rotating component. Thus the part of the fan from which the flow of the flow medium exits, such as a distribution ring or an opening, has no vanes, rotor blades or rotating components. This vaneless design enables a wobbling and/or an inconsistent exit of the flow of the flow medium as it flows out from the fan to be prevented. A smooth flow of the flow medium or air flow from the flow device thus results. In addition the lack of a large rotating fan wheel results in less contamination in the interior of the housing than with a housing unit with a prior-art fan. It also results in a reduction in noise, since a large volume of the flow medium is not being moved.

Regardless of the above description and without any effect on the definition of the fan as vaneless, the flow device can have a primary source for the first flow of the flow medium. This primary source can be any apparatus deemed by the person skilled in the art as being able to be used, such as a pump, a generator or a motor, wherein this can have a rotor and a fan wheel. This definition of the vaneless fan also does not extend to components of the flow device which perform secondary functions, such as for example adjusting an angle or changing the flow intensity.

An opening here is to be understood for example as a hole or a slot. Basically a number of holes or slots can also be provided here.

In this context a Coanda surface is to be understood as a surface on which a flow medium, which exits from an opening and follows a surface, exhibits the Coanda effect. With this effect the flow of the flow medium has the tendency to “run along” a convex surface, instead of coming away from the surface and continuing to move in the original direction of movement. The Coanda effect is a widely known and proven follower effect whereby a primary media flow is diverted over a Coanda surface. A description of the features of a Coanda surface and also of the effect of the media flow on the Coanda surface can be found in scientific publications, such as for example in Reba, Scientific American, Issue 214, June 1966, pages 84 to 92.

The phrase “in a predetermined direction” is to be understood here as the first flow of the flow medium being blown out in a directed manner and in the direction of a component able to be arranged in the housing, such as especially the rotor, the stator and/or the winding heads, for the purpose of cooling said components.

The flow device or the fan is preferably arranged in an axial direction of the shaft of the electric machine able to be arranged in the housing at an axial distance in front of and/or behind the electric machine.

It is further proposed that the fan has at least one distribution duct for at least the first flow of the flow medium. In this context a distribution duct is to be understood as a structure which encloses the flow of the flow medium and/or predetermines a direction of the flow. Advantageously the distribution duct supplies the at least one opening with flow medium. The implementation of the distribution duct enables the flow medium to be conveyed and supplied to the opening in a constructively simple manner.

The distribution duct can be any shape appearing conceivable to the person skilled in the art, such as race track shaped, bar shaped, polygonal, square, oval, semicircular and especially circular. Advantageously the distribution duct extends at least over a part area of the fan, whereby the flow of the flow medium can be distributed sufficiently over the fan. A part area here can be an angular area, a sector of a ring, a half of a ring or preferably a ring. The at least one opening is preferably adapted to the design of the distribution duct and extends along its entire length. In particular the opening is embodied as a slot which is concentric to the distribution duct or to its ring shape.

In addition it is proposed that the fan is embodied in a ring shape. This enables the fan to be realized with a low weight. This also means that the fan has a central cutout, whereby the fan can be integrated in a space-saving manner into the housing unit. For example the fan can be arranged so that the axis of the electric machine passes through the opening. A cooling, for example of the rotor or of the stator, can be undertaken especially evenly here if the fan extends centrally around the shaft. Basically however a non-centric arrangement would also be conceivable.

The ring shape also gives the distribution duct and the fan the same shape, whereby the distribution duct can be integrated into the fan in a constructively simple manner. Thus the distribution duct extends along the entire circumference of the fan. Preferably a wall of the distribution duct forms a basic shape of the fan and/or the fan represents a wall of the distribution duct.

It is further advantageous for the at least one opening to have an opening direction which is essentially aligned coaxially to an axis of a component able to be rotated around the axis and able to be arranged in the housing. In this context an opening direction is to be understood as a direction which extends in the same direction as the direction of flow of the flow medium.

The opening direction thus points towards the components of the electric machine able to be arranged in the housing. The term “essentially coaxial” is to be understood as a deviation of the opening direction from the axis with an angle of up to 30° also being able to be understood as a coaxial arrangement. Preferably the opening direction and the axis of the component able to be rotated around the axis of rotation and arranged in the housing are however parallel to one another. The inventive alignment enables the first flow of the flow medium to flow out of the opening without hindrance and without turbulences.

Advantageously the at least one opening is embodied to give the fan the effect of a nozzle. This enables the first flow of the flow medium to be accelerated in a constructively simple manner. As a consequence of the accelerated exit of the first flow of the flow medium from the at least one opening and the interaction with the Coanda surface, a second flow of the flow medium flowing around the fan can be dragged along. Ultimately a total media flow exiting from the flow device will be amplified by a multiple compared to the first flow of the flow medium. This amplification has a factor of 15 for example. The central cutout of the fan also proves advantageous here, since the second flow of the flow medium can be supplied unhindered and caught dragged along in this way.

The Coanda surface can have any orientation deemed practicable by the person skilled in the art or can be arranged at any conceivable location in the area of the opening, preferably directly on the opening. In a further embodiment of the invention there is provision however for the Coanda surface to be arranged in a flow direction of the flow medium downstream of the at least one opening of the distribution duct. Here the opening represents an exit point of the first flow of the flow medium from the distribution duct. The opening is also arranged on the distribution duct at the points at which, with a configuration of two neighboring walls of the distribution duct, one of these walls ends. In addition an extent surface of the opening is aligned at right angles to the flow or opening direction respectively, wherein the extent surface, starting from the end of the shorter wall, is oriented at right angles to the opposite wall. By means of this arrangement the first flow of the flow medium can flow directly over the Coanda surface after its exit from the opening.

It is further proposed that the Coanda surface runs symmetrically to an axis. In particular the axis coincides with an axis through a circle center point of the fan or of the distribution duct. In addition the axis runs coaxially with the shaft able to be arranged in the housing. This course enables the first flow of the flow medium to be adapted to an arrangement of the components concentric relative to the axis, which leads to an especially effective cooling.

Expediently the Coanda surface and the axis enclose an angle of between 7° and 20° and especially of 15°. These values have been proven for a use of the Coanda effect. With these values a sufficient first flow of the flow medium over the Coanda surface can be achieved which leads to an effective dragging along of the second flow of the flow medium and thus to a maximum total medium flow.

Trouble-free operation of the electric machine can be advantageously achieved when the fan is formed from a non-magnetic material. The material here is preferably a plastic which is resistant to high temperatures, such as for example polyimide, polyetherimide or polyacrynitrile. Generally however any other material deemed by the person skilled in the art as being usable can be used. It can also be advantageous for the material to be embodied electrically-conducting. In particular aluminum, copper or polyacrynitrile would be able to be used here.

Furthermore it can be advantageous for the housing unit to have a flow machine which sucks in the first flow of the flow medium and supplies it to the distribution duct of the fan. The flow machine is the primary source described above for generating the first flow and is embodied as a turbo unit or an electric motor with fan wheel. The flow medium is preferably sucked in here from outside the housing via a recess of a machine housing of the flow machine open to the outside. The flow is supplied to the distribution duct in its turn via a connecting duct, which is arranged in the flow direction after the fan wheel. By means of the flow machine the flow of the flow medium can be generated and supplied to the distribution duct in a constructively simple manner.

The flow machine can be arranged completely within, partly within, partly outside or completely outside the housing. Advantageously however a portion is arranged outside the housing, which facilitates maintenance by providing easy access and/or offers an opportunity of setting parameters by means of operating elements of the flow machine. In addition the flow machine, in a normal working mode of the electric machine able to be arranged in the housing, is arranged in the radial direction above the shaft, whereby the entry of the flow medium into the recess of the machine housing of the flow machine is facilitated.

A further embodiment of the invention makes provision for the fan to be embodied in one piece with the housing. In this context, in one piece is to be understood as the fan and the housing only being able to be separated from one another if the function of at least one of the two components is lost. Here the fan can be molded into the housing during the manufacturing of said housing or the fan and the housing are manufactured as one component, preferably by means of an injection molding method.

A preferred development includes the housing having an area which is arranged on one side of the fan which points in a direction which is oriented against the direction of flow of the first flow of the flow medium exiting from the at least one opening. The availability of the area enables space or a chamber to be created for the second flow of the flow medium.

Advantageously this area is able to be supplied with the second flow of the flow medium through at least one recess of the housing. The recess is preferably arranged in the area of the housing in which the flow machine is also arranged, whereby an inflow of the flow medium can take place unhindered from outside the housing and in normal working mode from above. The recess advantageously enables new flow medium to be supplied continuously.

It is also proposed that the housing unit has at least one cooling device for cooling the at least first flow of the flow medium. A cooling device is to be understood here as any cooling device deemed usable by the person skilled in the art, such as for example air cooling via a component of the electric machine or via fans arranged externally from the housing, liquid cooling or water jacket cooling for direct cooling of a component of the electric machine and especially a heat exchanger, liquid cooling, water jacket cooling or fresh water cooling of the housing. The cooling device is connected upstream of the flow device in a flow path of the flow medium. It can be arranged centrally or decentrally around the housing and is preferably integrated into a jacket of the housing. Preferably the second flow of the flow medium is also cooled. The total flow of the flow medium exiting from the flow device, after flowing around the components of the electric machine, can also leave the housing again and be supplied anew to the first and/or the second flow of the flow medium. This produces a flow medium circulation. By means of the cooling device flow medium already re-cooled can be supplied as first and second flow to the flow device and/or the area next to the fan via recesses in the flow machine and the housing. This results in lower energy losses compared to prior-art systems.

It is further proposed that the housing unit has an electric machine which is arranged at least partly in the housing. In particular the rotor, the stator and the winding heads of the electric machine are arranged in the housing here. The shaft of the electric machine on the other hand can pass through the housing in the axial direction and can thus be arranged partly outside the housing.

An embodiment of the invention is also based on an electric machine with at least one housing unit.

In addition it is advantageous for the flow device to have a fan with a flow machine, wherein the flow machine sucks in a first flow of the flow medium and supplies it to a distribution duct of the fan and wherein the first flow of the flow medium, after exiting from at least one opening of the distribution duct diverted by a Coanda surface of the fan blows onto at least one component of the electric machine and wherein the housing has an area which is arranged on one side of the fan which points in a direction which is oriented opposite to the flow direction of the first flow of the flow medium exiting from the at least one opening, wherein this area is able to be supplied through at least one recess of the housing with a second flow of the flow medium.

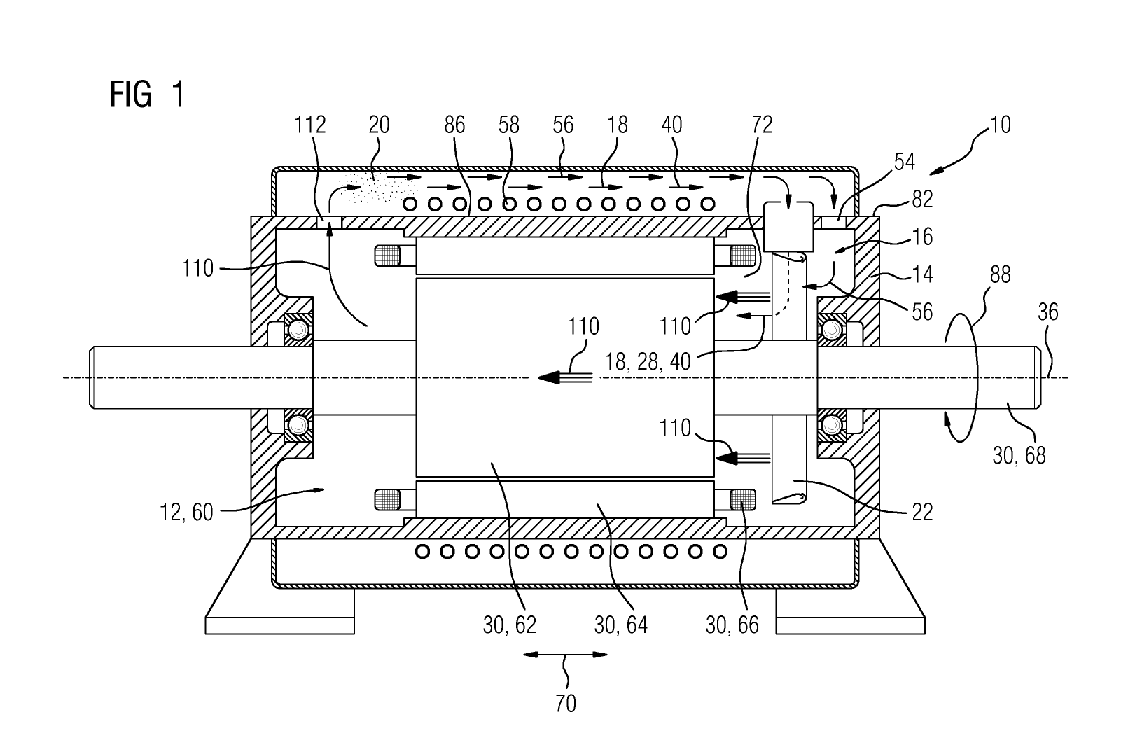

FIG. 1 shows an electric machine 12 in the form of a high-temperature superconductor motor 60, which is arranged at least partly in a housing 14 of a housing unit 10. Individual components 30, such as a rotor 62, a stator 64 or winding heads 66 of the motor 60, are arranged completely within the housing 14. A shaft 68, which extends along an axis 36 and which drives the rotor 62, passes through the housing 14 in an axial direction 70.

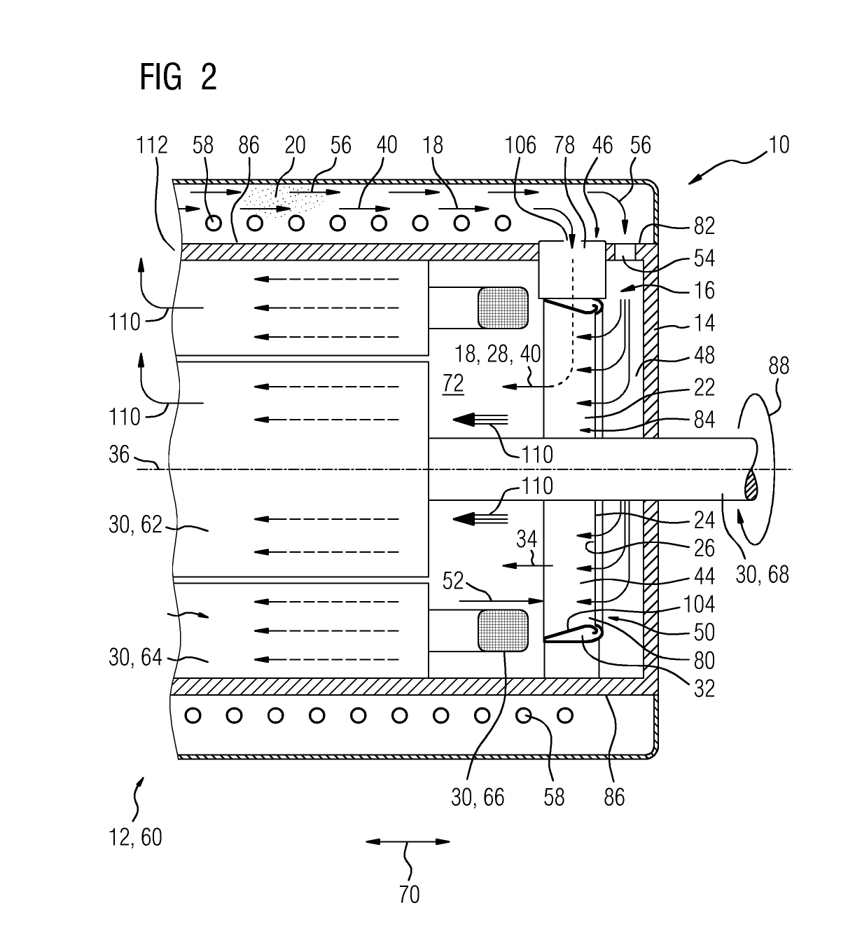

The housing unit 10 has a flow device 16 for generating a first flow 18 of a flow medium 20 in the form of air. Here the first flow 18 of the flow medium 20 flows from outside the housing 14 along the flow device 16 in a flow direction 40 into an inner space 72 of the housing 14 (see FIG. 2). The flow device 16 is arranged axially spaced within the housing 14 in the axial direction 70 of the shaft 68 behind the electric machine 12.

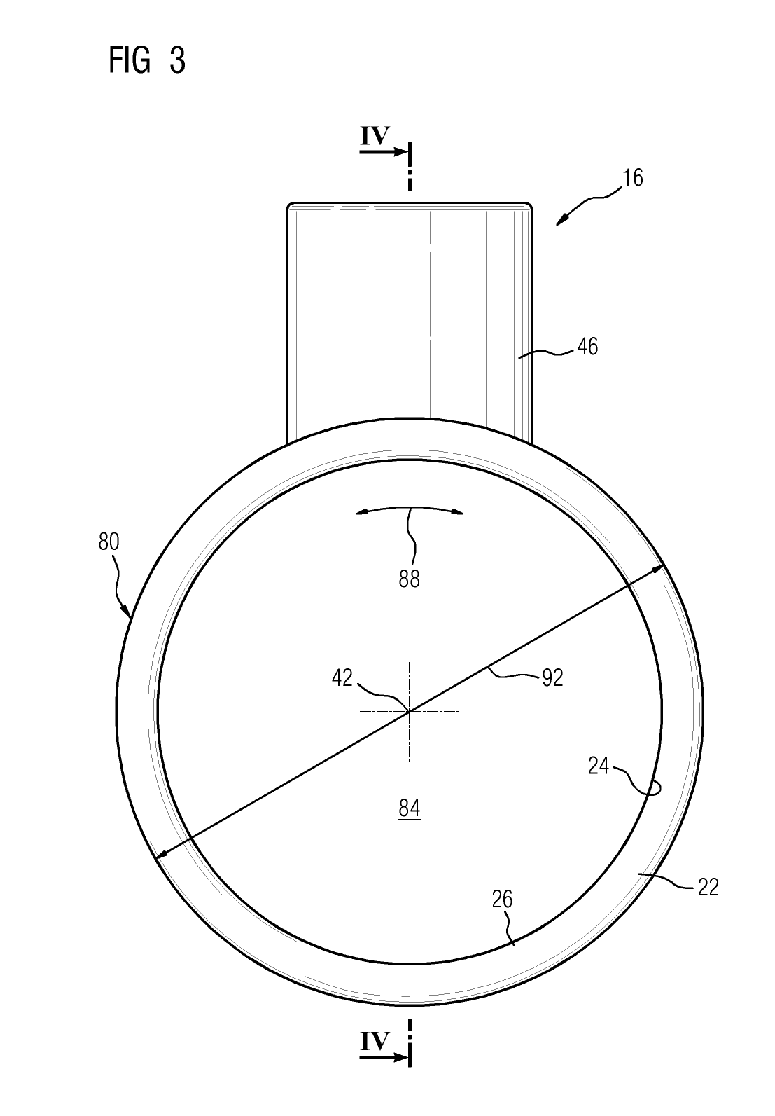

FIG. 2 shows a detailed cross-section of the area of the housing 14 in which the flow device 16 is arranged. The flow device 16 has a fan 22 and a flow machine 46 in the form of an electric motor 74 with a fan wheel 76 in a machine housing 78 (see FIG. 3). The fan 22 is formed from a non-magnetic material 44, such as the plastic polyimide. The fan 22 is also embodied in the shape of a ring, wherein the ring 80 extends centrally around the axis 36 or the shaft 68 respectively. The flow machine 46 is arranged on a side of the ring 80 facing away from the shaft 68 and on an upper side 82 of the housing 14. The flow machine 46 sucks in the first flow 18 of the flow medium 20 and supplies this to a distribution duct 32 of the fan 22. Control elements, not shown here, can be arranged on the flow machine 46 on a side pointing outwards, to set a speed of the electric motor 74 for example.

The housing 14 has an area 48 which is arranged on one side 50 of the fan 22, which points away from the electric machine 12. The area 48 is supplied through a recess 54 on the upper side 82 of the housing 14 with a second flow 56 of the flow medium 20. This second flow 56 flows from outside the housing 14 through the recess 54 into the area 48 and from there through a cutout 84 of the ring 80 in the direction of the electric machine 12.

On an outer surface 86 of the housing 14 a cooling device 58 for cooling the first flow 18 and the second flow 56 of the flow medium 20 is arranged in the circumferential direction 88 around the housing 14. The cooling device 58 formed by a heat exchanger is connected upstream of the flow device 16 in a flow path of the flow medium 20. This means that cooled flow medium 20 already enters into the flow device 16 and the area 48.

FIG. 3 shows the flow device 16 on its own. As described above, the flow device 16 has a flow machine 46 and a ring-shaped fan 22. The ring 80 extends centrally around the axis 36 and, with its form and extent, defines the cutout 84.

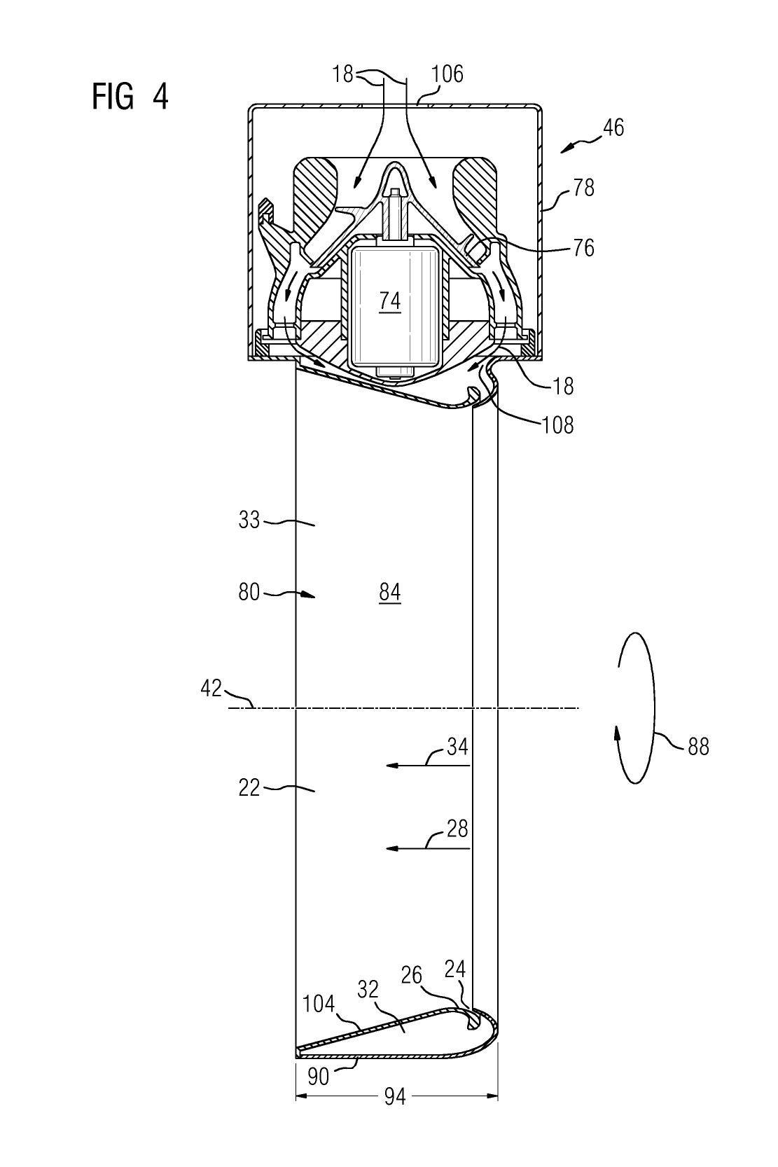

As can be seen in FIG. 4, which shows a section along the line IV-IV in FIG. 3, the fan 22 has the distribution duct 32 for the first flow 18 of the flow medium 20, an opening 24 on the distribution duct 32, whereby this is supplied by the distribution duct 32 with flow medium 20, and a Coanda surface 26. The distribution duct 32 is likewise embodied in the shape of a ring and thus extends in the circumferential direction 88 over a part area 33 and especially over the entire circumference of the fan 22. The fan 22 forms a wall 90 of the distribution duct 32. In the example embody shown the fan 22 or the ring 80 have an external diameter 92 of 350 mm (cf. FIG. 3). A width 94 of the fan coaxial to the axis 42 amounts to 50 mm, wherein the distribution duct 32 is narrower by the extent of the wall 90.

The opening 24 has an opening direction 34, which is aligned coaxially to the axis 36 of the component 30 which can be rotated around the axis 36 or of the rotor 62 and the flow direction 40. The opening 24 is also formed by a ring-shaped slot, which extends along the ring 80 of the fan 22.

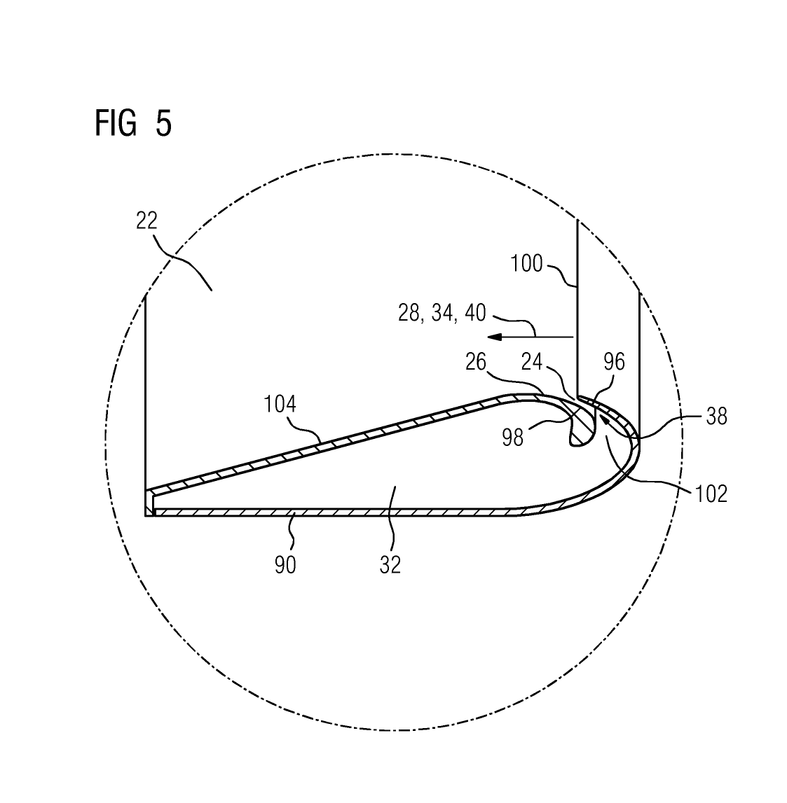

As can be seen in FIG. 5, the wall 90 of the fan has an inner wall area 96 and an outer wall area 98 in the region of the opening 24, which are arranged opposite one another in a folded arrangement. A fictitious extent surface of the opening 24 extends, starting from an end 100 of the inner wall area 96, at right angles to the opposing outer wall area 98 and at right angles to the flow direction 40 or opening direction 34. An extent of the opening 24 along the extent surface from end 100 to the opposite outer wall area 98 is between 1 mm and 5 mm wide, preferably 1.3 mm. Arranged in the flow direction 40 before the opening 24 is a constriction area 102 running conically towards the opening 24, through which the opening 24 is embodied to give the fan 22 the effect of acting as a nozzle 38.

The Coanda surface 26 is arranged in the area of the opening 24 and in flow direction 40 of the flow medium 20 downstream of the opening 24. The Coanda surface 26 runs symmetrically to the axis 42. Furthermore the Coanda surface 26 and the axis 42 enclose an angle of 15°. A guide surface 104 is arranged in the flow direction 40 downstream of the Coanda surface 26 which extends over two thirds of the width 94 of the fan 22. The guide surface 104 and the general design of the fan 22 are tailored to a shape of a support surface.

With the aid of the Coanda surface the first flow 18 of the flow medium 20 exits in a predetermined direction 28 and indeed in the direction of the electric machine 12 from the opening 24 and blows onto the components 30 arranged in the housing 14 in a targeted manner (cf. FIG. 2). In addition the guide surface 104 supports the directed outflow of the first flow 18 in this case.

The functioning of the flow device 16 is described in greater detail below with reference to FIGS. 2 to 5. The electric motor 74 of the flow machine 46, which is arranged in the machine housing 78, sucks in the first flow 18 of the flow medium 20 from outside the housing 14 through a recess 106 in the machine housing 78 and into the machine housing 78. In this example embodiment the sucked in amount of flow medium 20 amounts to between 20 and 30 liters per second and preferably around 27 liters per second. A fan wheel 76 arranged on the electric motor 74 and driven by it diverts the first flow 18 of the flow medium 20 through a connection duct 108 into the distribution duct 32 of the fan 22. The first flow 18 of the flow medium 20 is first constricted in the constriction area 102 and then at the opening 24 before its exit from the opening 20.

The outflow of the flow 18 from the opening 24 generates a vacuum at the recess 106 and leads to a further sucking in of flow medium 24 through the recess 106 into the flow device 16. The flow of the first flow 18 over the Coanda surface 26 and the guide surface 104 amplifies the first flow 18 of the flow medium 20 by means of the Coanda effect. Also the second flow 56 of the flow medium 20 is influenced. This is located or flows in area 48, which is arranged on the side 50 of the fan 22, wherein the side 50 points in a direction 52 which is oriented against the direction of flow 40 of the first flow 18 of the flow medium 20 exiting from the opening 24. The direct vicinity of the area 48 and the fan 22 or the opening 24 means that the second flow 56 is dragged along by the first flow 18. Here the second flow 56 flows through the cutout 84, wherein a part can flow over the guide surface 104, and combines with the first flow 18 to a total flow 110 of the flow medium 20. The total flow 110 in this case can have a flow volume of 500 to 700 liters per second. The total flow 110 now flows in direction 28 or in flow direction 40 to the components 30 of the electric machine 12 in order to flow through and thus cool said elements. After it has flowed through the components 30 the total flow 110 is diverted again out of the housing 14 through a cutout 112 and can be fed once again to the first flow 18 and the second flow 56 of the flow medium 20 (cf. FIG. 2).

For a distance of around 1000 mm between the flow device 16 and the components 30 to be cooled the flow volume can still amount to a quantity of 400 to 500 liters per second. The total flow 110 can have a speed of 3 to 4 meters per second. Higher speeds can be achieved by reducing the angle which is enclosed between the Coanda surface and the axis. A smaller angle leads to the total flow flowing out in a more focused and more direct manner. Such a total flow is ejected at a higher speed and a reduced flow volume rate. Conversely a larger flow volume rate can be achieved by enlarging the angle which is enclosed between the Coanda surface and the axis. Here the speed of the total flow is reduced, wherein however the flow volume rate will be increased.

The dimensions and power of the flow device are dependent on the electric machine and the application for which it is used. The values specified here by way of example must accordingly be adapted by the person skilled in the art, depending on the field of use.

As an alternative a housing can also be formed by an outer housing of an electric machine in the form of a low-voltage machine. Here a shaft is also completely arranged in the housing. In such an arrangement a second flow of the flow medium comes from the direction of a bearing shield which is arranged opposite a take-off drive side of the machine for example (B bearing shield) (not shown).

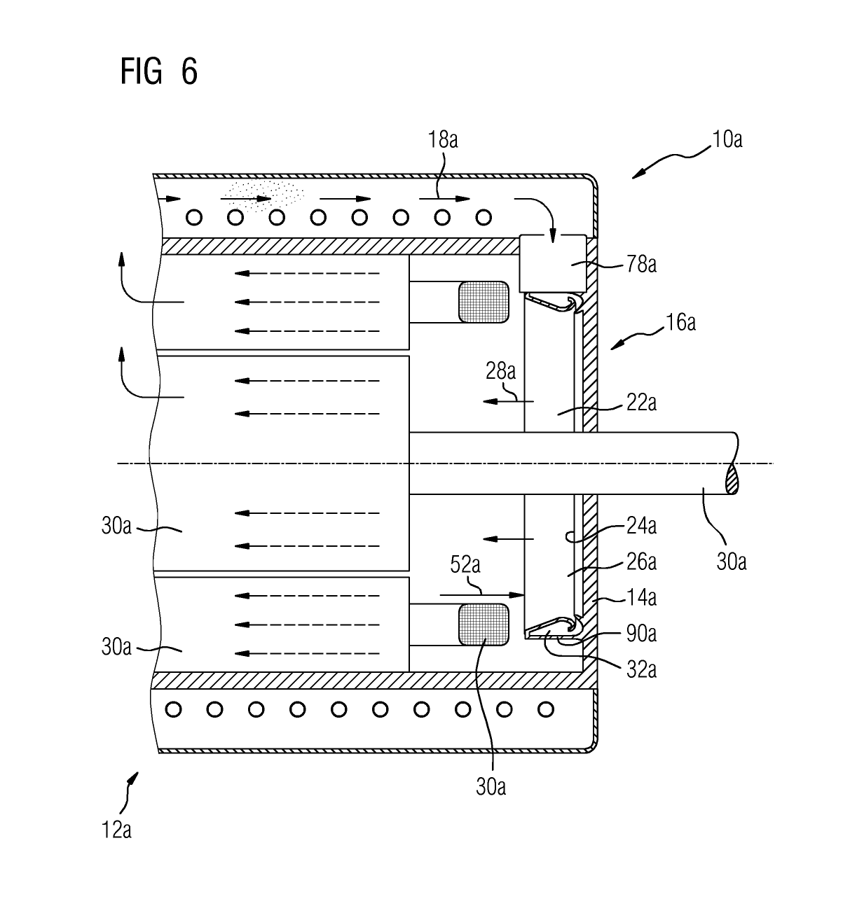

FIG. 6 shows an alternate example embodiment of the housing unit 10. Essentially components, features and functions which remain the same are basically labeled with the same reference characters. To distinguish between the example embodiments however the reference characters of the example embodiment of FIG. 6 have the letter a appended to them. The description given below is restricted essentially to the differences from the example embodiment in FIGS. 1 to 5, wherein the reader can be referred, in relation to components, features and functions that remain the same, to the description of the example embodiment in FIGS. 1 to 5.

The example embodiment of FIG. 6 differs from that of FIGS. 1 to 5 in that a housing unit 10a for an electric machine 12a has a housing 14a and a flow device 16a with a fan 22a, wherein the fan 22a is designed in one piece with the housing 14a. Here the fan 22a and especially a wall 90a of a distribution duct 32a of the fan 22a have been integrated in an injection molding method into the housing 14a during manufacture of the housing 14a. A machine housing 78a for a flow machine 46a can also be designed in one piece with the housing 14a.

As an alternative these components can also be molded into the housing during manufacture of a housing.

1. A housing unit for an electric machine, comprising:
at least one housing; and
at least one flow device configured to generate at least one first flow of a flow medium, wherein the flow device being arranged within the at least one housing and including at least one fan, the at least one fan including at least one opening and a Coanda surface, the Coanda surface being arranged in a region of the at least one opening, wherein the at least one fan is configured such that the at least one first flow of the flow medium will exit the at least one opening in a predetermined direction and wherein at least one component, arrangeable in the housing, is subjectable to incident blowing in a targeted manner.

2. The housing unit of claim 1, wherein the at least one fan includes at least one distribution duct for at least the first flow of the flow medium, and wherein the at least one distribution duct is configured to supply the at least one opening with flow medium.

3. The housing unit of claim 1, wherein the at least one fan includes at least one distribution duct for at least the at least one first flow of the flow medium, and wherein the distribution duct extends at least over a part area of the at least one fan.

4. The housing unit of claim 1, wherein at least one of
the at least one opening includes an opening direction, aligned essentially coaxial to an axis of a component rotatably arrangable around the axis and in the housing, and
the at least one opening is embodied to impart an effect of a nozzle to the at least one fan.

5. The housing unit of claim 2, wherein the Coanda surface is arranged in a flow direction of the flow medium downstream of the at least one opening of the distribution duct.

6. The housing unit of claim 1, wherein at least one of
the Coanda surface runs symmetrically to an axis, and
the Coanda surface and the axis enclose an angle between 7° and 20°.

7. The housing unit of claim 1, wherein the at least one fan is formed from a non-magnetic material.

8. The housing unit of claim 1, wherein the at least one fan is embodied in the shape of a ring.

9. The housing unit of claim 1, further comprising:
a flow machine, configured to suck-in the first flow of the flow medium and supply the first flow of the flow medium to a distribution duct of the at least one fan.

10. The housing unit of claim 1, wherein the at least one fan is embodied in one piece with the housing.

11. The housing unit of claim 1, wherein the housing includes an area, arranged on one side of the at least one fan, which points in a direction oriented against the direction of flow of the first flow of the flow medium exiting from the at least one opening, and wherein the area is able to be supplied with a second flow of the flow medium through at least one cutout of the housing.

12. The housing unit of claim 1, further comprising:
at least one cooling device configured to cool the at least one first flow of the flow medium.

13. The housing unit of claim 1, further comprising:
an electric machine, arranged at least partly in the housing.

14. An electric machine, comprising at least one housing unit as claimed in claim 1.

15. The electric machine of claim 14, wherein the flow device includes a fan with a flow machine, wherein the flow machine is configured to suck in a first flow of the flow medium and supplies the first flow to a distribution duct of the fan, wherein the first flow of the flow medium, after exiting from at least one opening of the distribution duct, diverted by a Coanda surface of the fan, blows onto at least one component of the electric machine in a targeted manner, wherein the housing includes an area arranged on one side of the fan, which points in a direction oriented against the flow direction of the first flow of the flow medium exiting from the at least one opening, and wherein the area is able to be supplied with a second flow of the flow medium through at least one cutout of the housing.

16. The housing unit of claim 2, wherein the at least one fan includes at least one distribution duct for at least the at least one first flow of the flow medium, and wherein the distribution duct extends at least over a part area of the at least one fan.

17. The housing unit of claim 2, wherein at least one of
the at least one opening includes an opening direction, aligned essentially coaxial to an axis of a component rotatably arrangable around the axis and in the housing, and
the at least one opening is embodied to impart an effect of a nozzle to the at least one fan.

18. The housing unit of claim 6, wherein at least one of
the Coanda surface runs symmetrically to an axis, and
the Coanda surface and the axis enclose an angle of 15°.

19. The housing unit of claim 2, further comprising:
at least one cooling device configured to cool the at least one first flow of the flow medium.

20. The housing unit of claim 2, further comprising:
an electric machine, arranged at least partly in the housing.
